(19) United States
(12) Patent Application Publication
(10) Pub. No.: US 2015/0347967 A1
(43) Pub. Date: Dec. 3, 2015

(54) Support System, Support Method, and Recording Medium for Promoting Usage

(71) Applicant: Kyocera Document Solutions Inc., Osaka (JP)

(72) Inventor: Koki Nakajima, Osaka (JP)

(21) Appl. No.: 14/726,461

(22) Filed: May 30, 2015

(30) Foreign Application Priority Data
May 30, 2014 (JP) 2014-112552
May 30, 2014 (JP) 2014-112557

(51) Int. Cl. G06Q 10/10; G06F 17/30

(52) U.S. Cl. CPC G06Q 10/10; G06F 17/30876

(57) ABSTRACT

A support system includes a function execution circuit, a customer-information managing circuit, and a usage-availability setting circuit. The function execution circuit uses customer information indicative of a specific content related to a customer to execute a specific function. The customer-information managing circuit manages the customer information for each dealer. The usage-availability setting circuit sets availability for use of the customer information from a person having authority to manage the dealer for each of the dealers. The customer-information managing circuit determines the availability for use based on setting by the usage-availability setting circuit.

### INCORPORATION BY REFERENCE

This application is based upon, and claims the benefit of priority from, corresponding Japanese Patent Application Nos. 2014-112552 and 2014-112557, each filed in the Japan Patent Office on May 30, 2014, the entire contents of which are incorporated herein by reference.

### BACKGROUND

Unless otherwise indicated herein, the description in this section is not prior art to the claims in this application and is not admitted to be prior art by inclusion in this section.

A typical support system, which supports sales in a dealer who sells a product to a customer, is known as a support system that uses customer information indicative of specific contents related to the customer, to execute a specific function.

### SUMMARY

A support system according to an aspect of the disclosure includes a function execution circuit, a customer-information managing circuit, and a usage-availability setting circuit. The function execution circuit uses customer information indicative of a specific content related to a customer to execute a specific function. The customer-information managing circuit manages the customer information for each dealer. The usage-availability setting circuit sets availability for use of the customer information from a person having authority to manage the dealer for each of the dealers. The customer-information managing circuit determines the availability for use based on setting by the usage-availability setting circuit.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates the configuration of a system according to a first embodiment of the disclosure.

FIG. 2 illustrates the relationship between an administrator of a support server and a dealer according to the first embodiment.

FIG. 3 illustrates the configuration of the support server according to the first embodiment.

FIG. 4 illustrates an example of reference-availability setting information according to the first embodiment.

FIG. 5 illustrates the behavior of the support server according to the first embodiment when a management-node list is referenced.

FIG. 6 illustrates an example of the management-node list displayed on a display unit according to the first embodiment.

FIG. 7 illustrates an example of the management-node list according to the first embodiment when unique information of the dealer is displayed.

FIG. 8 illustrates the behavior of the support server according to the first embodiment when a dealer is added to the management-node list.

FIG. 9 illustrates the behavior of the support server according to the first embodiment when lower hierarchy reference is changed from a prohibited condition to a permitted condition.

FIG. 10 illustrates the behavior of the support server according to the first embodiment when the use of a function is requested.

FIG. 11 illustrates the configuration of a system according to a second embodiment of the disclosure.

FIG. 12 illustrates the relationship between an administrator of a support server and a dealer according to the second embodiment.

FIG. 13 illustrates the configuration of the support server according to the second embodiment.

FIG. 14 illustrates an example of customer-information-storage-destination information according to the second embodiment.

FIG. 15 illustrates the configuration of a user terminal according to the second embodiment.

FIG. 16 illustrates the behavior of the system according to the second embodiment when the dealer requests the use of a function from the support server.

FIG. 17 illustrates the behavior of the system when a dealer different from the dealer who has requested the use of the function from the support server requests the use of a function from the support server, in the sequence diagram according to the second embodiment.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

### First Embodiment

The following describes a first embodiment of the disclosure with reference to the drawings.

Firstly, a description will be given of the configuration of a system 10 according to this embodiment.

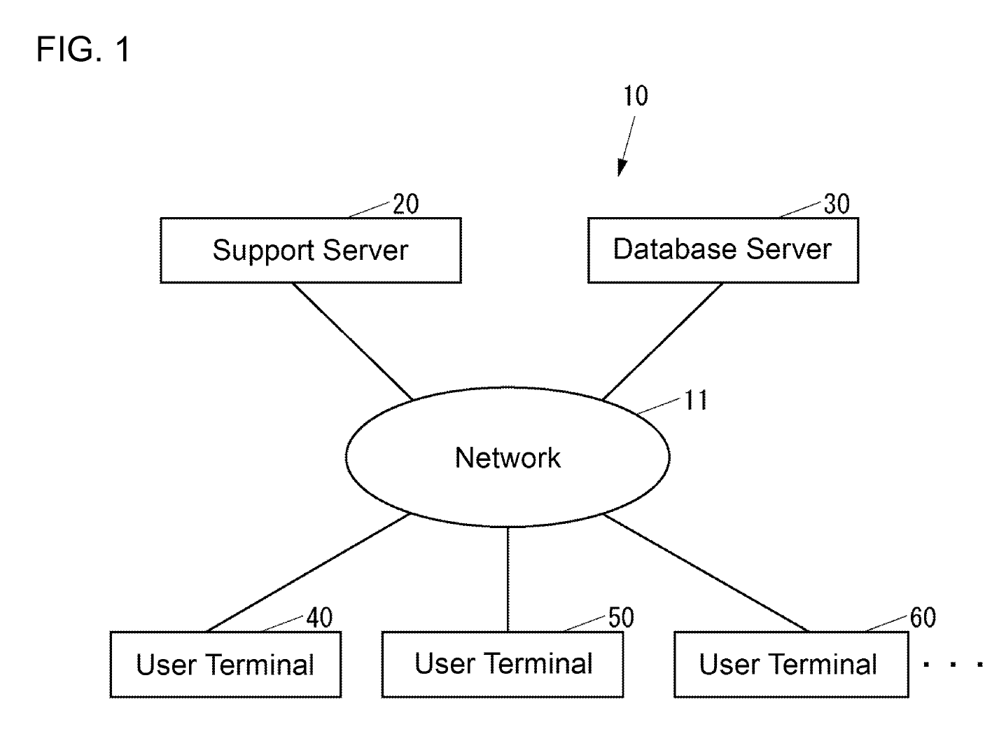

FIG. 1 illustrates the configuration of the system 10 according to this embodiment.

As illustrated in FIG. 1, the system 10 includes: a support server 20; a database server 30; and a user terminal 40, a user terminal 50, and a user terminal 60, which are used by the dealer. The support server 20 supports sales in a dealer who sells a product to a customer, as a support system. The database server 30 stores various kinds of information including customer information indicative of specific contents related to the customer.

The support server 20, the database server 30, the user terminal 40, the user terminal 50, and the user terminal 60 are communicatively connected to one another via a network 11 such as the Internet.

Here, the system 10 can include a lot of user terminals similar to the user terminal 40 other than the user terminal 40, the user terminal 50, and the user terminal 60.

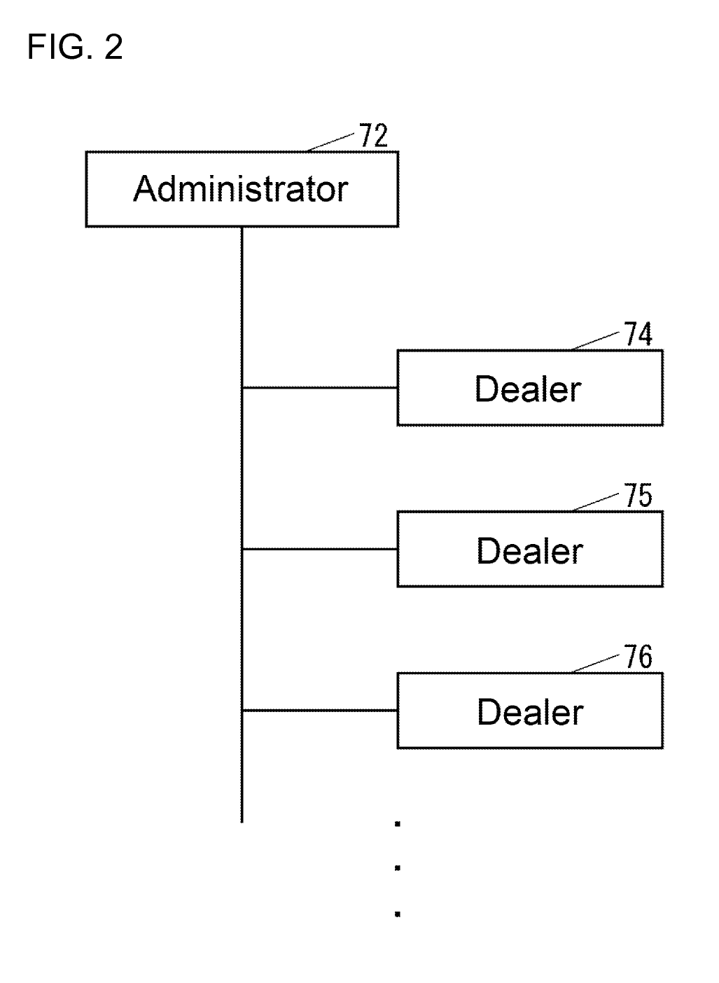

FIG. 2 illustrates the relationship between an administrator 72 of the support server 20 (see FIG. 1) and dealers.

As illustrated in FIG. 2, users of the system 10 (see FIG. 1) include: the administrator 72 of the support server 20; and a dealer 74, a dealer 75, and a dealer 76 who sell products to customers.

Here, users of the support server 20 may include a lot of dealers other than the dealer 74, the dealer 75, and the dealer 76.

The administrator 72 is the person who has authority to manage the dealers in the support server 20 and who maintains and operates the support server 20. The administrator 72 is, for example, a sales company of a manufacturer of the product, which the dealer sells to the customer. For example, the support service, which is provided by the support server 20, includes services provided to a dealer to support the selling management of a product by the dealer and the operation of the product by the dealer, such that sales companies of a manufacturer promotes the usage of their own product. The sales companies of the manufacturer include a Regional Headquarter (RHQ), which controls a plurality of countries, and a Second Level (SC), which carries out the work limited in units of granularity of country or smaller granularity.

Here, such products may include, for example, electronic devices. The electronic devices may include, for example, office equipment. The office equipment may include, for example, image forming apparatuses such as a Multifunction Peripheral (MFP) and a printer-only machine. For example, the support server 20 may provide the support service such as a Managed Print Service (MPS) for the selling management of an image forming apparatus by a dealer and the operation of the image forming apparatus by the dealer.

The dealer is the person managed by the administrator 72 in the support server 20. However, the dealer is another juridical person independent from the administrator 72, and can handle not only the product of the administrator 72 but also any product such as a competing product to the product of the administrator 72.

The support server 20 and the database server 30 illustrated in FIG. exist in an on-premise environment or on a cloud network of the administrator 72 (see FIG. 2).

The database server 30 stores unique information of the dealer including the customer information for each dealer. The customer information includes a plurality of items of information. For example, the items of the customer information include the name of a customer. The items of the customer information include various attributes of the product possessed by the customer, for example, the model name, the setting, the state, and the use history of the product possessed by the customer.

The user terminals included in the system 10 are used by respective different dealers. For example, the users of the user terminals 40, 50, and 60 are the respective dealers 74, 75, and 76 (see FIG. 2).

The user terminals 40, 50, and 60 exist in the respective on-premise environments of the dealers 74, 75, and 76. The user terminal 40, the user terminal 50, and the user terminal 60 are constituted of, for example, computers such as a Personal Computer (PC) and a tablet terminal.

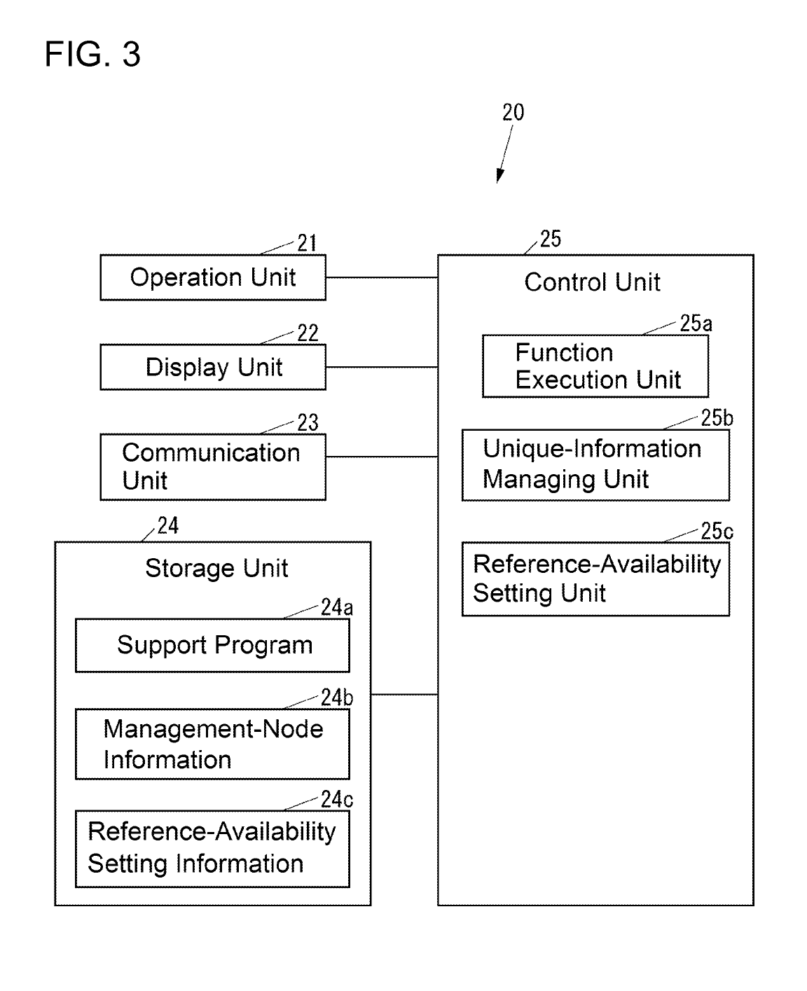

FIG. 3 illustrates the configuration of the support server 20.

As illustrated in FIG. 3, the support server 20 includes an operation unit 21, a display unit 22, a communication unit 23, a storage unit 24, and a control unit 25. The operation unit 21 is an input device that receives inputs of various operations, for example, a computer mouse and a keyboard. The display unit 22 is a display device that displays various kinds of information, for example, a Liquid Crystal Display (LCD). The communication unit 23 is a network communication device that communicates with an external device via the network 11 (see FIG. 1). The storage unit 24 is a storage device that stores a program and various data, for example, a Hard Disk Drive (HDD). The control unit 25 controls the entire support server 20. The support server 20 is constituted of, for example, a computer such as a PC.

The storage unit 24 stores a support program 24a, which supports sales in the dealer as the user of the user terminal. The support program 24a may be installed on the support server 20 at production stage of the support server 20, may additionally be installed on the support server 20 from a storage medium such as a Compact Disk (CD) and a Digital Versatile Disk (DVD), or may be additionally installed on the support server 20 through the network 11.

The storage unit 24 can store management-node information 24b indicative of various contents related to the person (hereinafter referred to as “management node”) such as the administrator and the dealer managed by the support server 20. For example, the management-node information 24b includes the combination of: the login ID and password of the administrator; and the name of the administrator. The management-node information 24b includes the combination of: the login ID and password of the dealer; and the name of the dealer.

The storage unit 24 can store reference-availability setting information 24c indicative of setting for availability of the reference (hereinafter referred to as “lower hierarchy reference”) to the unique information of a person in a lower hierarchy from a person in an upper hierarchy in the hierarchy of users in the support server 20.

The control unit 25 includes, for example, a Central Processing Unit (CPU), a Read Only Memory (ROM), which stores a program and various data, and a Random Access Memory (RAM), which is used as a work area of the CPU. The CPU can execute the program stored in the ROM or the storage unit 24, which is a non-transitory computer-readable recording medium.

The control unit 25 executes the support program 24a stored in the storage unit 24, so as to function as a function execution unit 25a, a unique-information managing unit 25b, and a reference-availability setting unit 25c. The function execution unit 25a executes a specific function using the customer information. The unique-information managing unit 25b manages the unique information including the customer information for each dealer, as a customer-information managing unit. The reference-availability setting unit 25c sets availability of the lower hierarchy reference for each dealer.

Possible functions executed by the function execution unit 25a include a function that supports selling of the product by the dealer. For example, a possible function generates a proposal for selling a new product that can improve the current situation of the customer, based on the use history of the product possessed by the customer of the dealer among the customer information of the dealer.

Possible functions executed by the function execution unit 25a include a function that supports the operation of the product by the dealer. For example, a possible function automatically orders the consumables of the product, based on the usage conditions of the consumables in the product possessed by the customer of the dealer among the customer information of the dealer. Another possible function remotely changes the setting in the product based on the state of the product possessed by the customer of the dealer among the customer information of the dealer. Another possible function determines whether or not the product is broken down based on the state of the product possessed by the customer of the dealer among the customer information of the dealer, and notifies the method of the necessary procedure when the product is broken down.

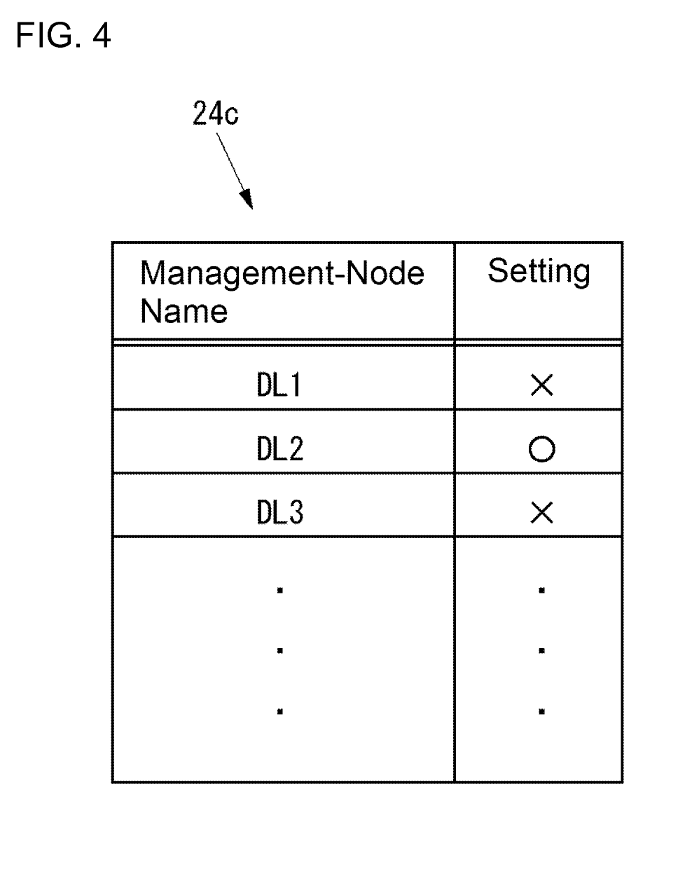

FIG. 4 illustrates an example of the reference-availability setting information 24c.

The reference-availability setting information 24c illustrated in FIG. 4 stores the relationship between: a management-node name indicative of the name of the management node; and setting for availability of the lower hierarchy reference.

In the example illustrated in FIG. 4, for a management-node name “DL1” indicative of the dealer 74 and a management-node name “DL3” indicative of the dealer 76, the setting for availability of the lower hierarchy reference is stored as “x,” that is, Prohibited. On the other hand, for a management-node name “DL2” indicative of the dealer 75, the setting for availability of the lower hierarchy reference is stored as “O,” that is, Permitted.

The following describes the behavior of the support server 20.

Firstly, a description will be given of the behavior of the support server 20 when the list (hereinafter referred to as “management-node list”) of the management nodes is referenced by the administrator 72.

The administrator 72 needs to login to the support server 20 before requesting the support server 20 to reference the management-node list. Instruction to login to the support server 20 via the operation unit 21 by the administrator 72 causes the control unit 25 of the support server 20 to: permit login of the administrator 72 when the combination of the ID and the password input via the operation unit 21 is included in the management-node information 24b; and not permit login of the administrator 72 when the combination of the ID and the password input via the operation unit 21 is included in the management-node information 24b.

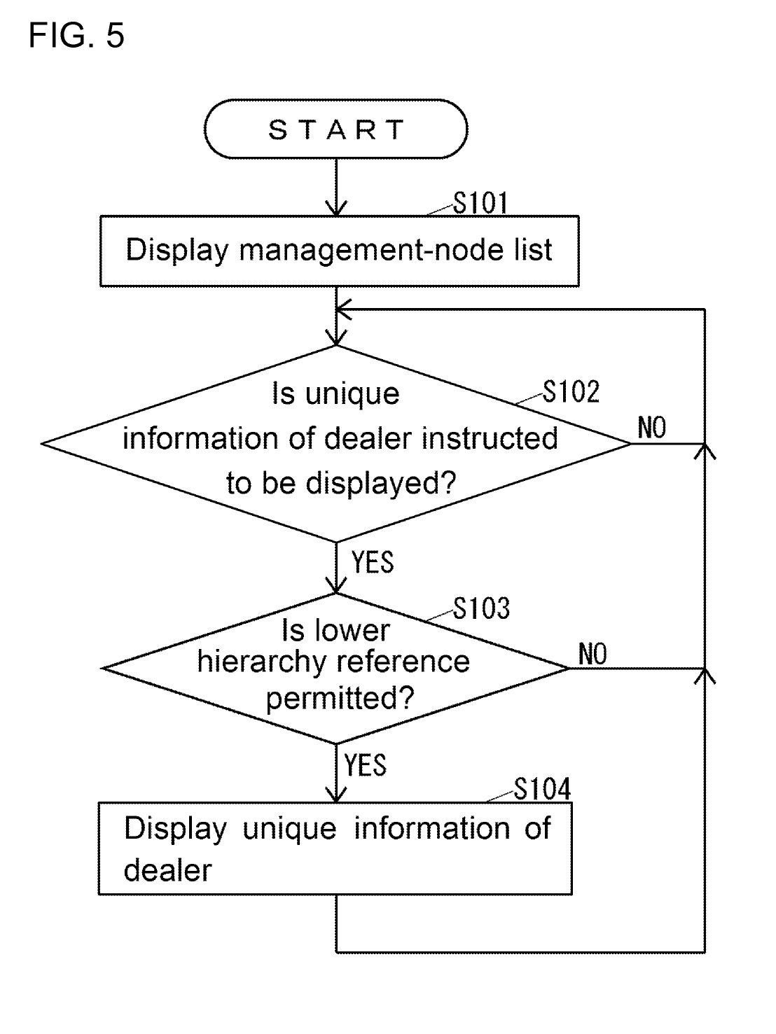

When the administrator 72 whose login has been permitted by the support server 20 requests the support server 20 to reference the management-node list, the control unit 25 of the support server 20 executes the behavior illustrated in FIG. 5.

FIG. 5 illustrates the behavior of the support server 20 when the management-node list is referenced.

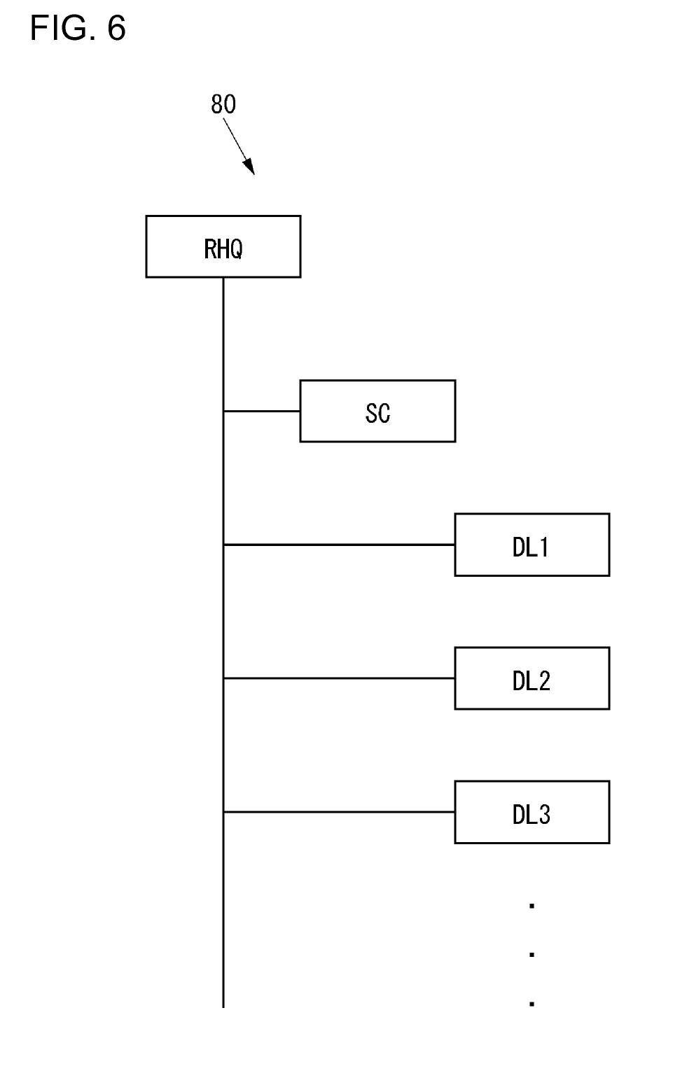

As illustrated in FIG. 5, the unique-information managing unit 25b displays, for example, a management-node list 80 as illustrated in FIG. 6 on the display unit 22 (in step S101).

The administrator 72 can specify any dealer in the management-node list 80 displayed on the display unit 22 via the operation unit 21 so as to instruct the support server 20 to display the unique information of the specified dealer.

After the process in step S101, the unique-information managing unit 25b determines whether or not display of the unique information of the dealer has been instructed via the operation unit 21, until it is determined that display of the unique information of the dealer has been instructed via the operation unit 21 (in step S102).

When the unique-information managing unit 25b determines that display of the unique information of the dealer has been instructed via the operation unit 21 in step S102, the unique-information managing unit 25b determines whether or not the reference to the specified dealer is set as permitted in the reference-availability setting information 24c (in step S103).

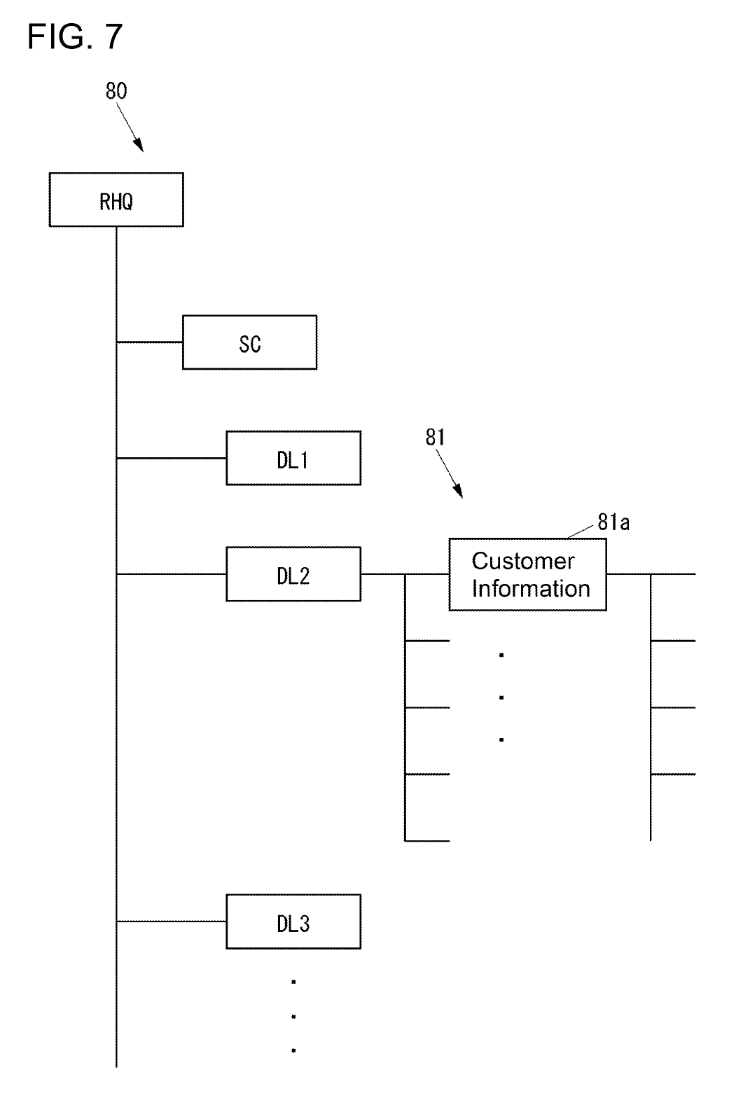

When the unique-information managing unit 25b determines the reference is set as permitted in step S103, the unique-information managing unit 25b displays unique information 81 of the dealer as illustrated in FIG. 7 in the management-node list 80 displayed on the display unit 22 (in step S104) and then executes the process in step S102.

When the unique-information managing unit 25b determines that the reference is not set as permitted in step S103, the unique-information managing unit 25b executes the process in step S102 without displaying the unique information of the dealer in the management-node list 80 displayed on the display unit 22.

FIG. 7 illustrates an example of the management-node list 80 when the unique information 81 of the dealer is displayed.

In the management-node list 80 illustrated in FIG. 7, the unique information 81 of the management-node name “DL2” indicative of the dealer 75 is displayed. The unique information 81 also includes customer information 81a of the dealer 75.

In the description above, the unique-information managing unit 25b determines the availability of reference to the unique information of the dealer, that is, a person in a lower hierarchy by the administrator 72 having authority to manage the dealer, that is, a person in an upper hierarchy compared with the dealer, corresponding to the reference-availability setting information 24c. Here, the unique-information managing unit 25b permits the person in the upper hierarchy to reference only the unique information of a person in a lower hierarchy in a direct line. That is, the unique-information managing unit 25b always prohibits the person who in the upper hierarchy from referencing the information of a person in a lower hierarchy in a collateral line. The unique-information managing unit 25b always prohibits the person in the lower hierarchy from referencing the information of a person in an upper hierarchy. Also, the unique-information managing unit 25b always prohibits a person in any hierarchy from referencing the information of a person in the identical hierarchy.

The following describes the behavior of the support server 20 when the administrator 72 adds a dealer to the management-node list.

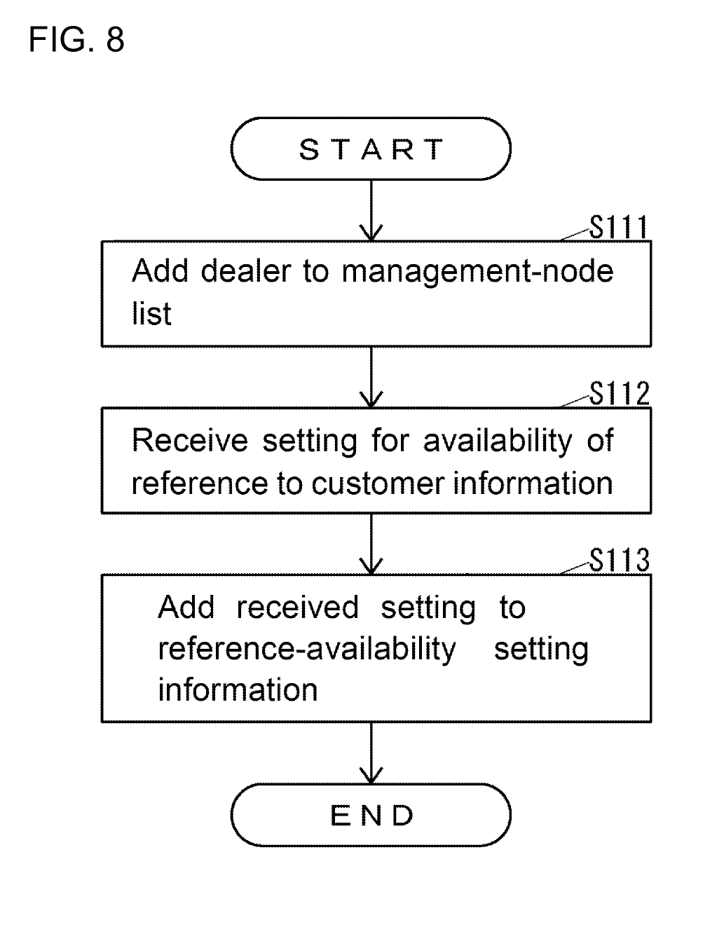

When the management-node list is displayed on the display unit 22 by the behavior illustrated in FIG. 5, the administrator 72 can select a desired part to which a dealer is added in the management-node list via the operation unit 21 to instruct addition of the dealer, so as to request the support server 20 to add the dealer to the management-node list. When the addition of the dealer to the management-node list is requested, the control unit 25 of the support server 20 executes the behavior illustrated in FIG. 8.

FIG. 8 illustrates the behavior of the support server 20 when the dealer is added to the management-node list.

As illustrated in FIG. 8, the unique-information managing unit 25b adds the dealer to the selected part in the management-node list (in step S111). Here, the unique-information managing unit 25b adds the login ID and the login password, which are input from the administrator 72, to the management-node information 24b as the login ID and password of the newly added dealer. Also, the unique-information managing unit 25b adds the name, which is input from the administrator 72, to the management-node information 24b as the name of the newly added dealer.

Subsequently, the reference-availability setting unit 25c displays a screen that receives setting for availability of the lower hierarchy reference on the display unit 22, so as to receive setting for availability of the lower hierarchy reference (in step S112).

Subsequently, the reference-availability setting unit 25c adds the setting received in step S112 for the dealer added in step S111, to the reference-availability setting information 24c (in step S113) and then terminates the behavior illustrated in FIG. 8.

Subsequently, a description will be given of the behavior of the support server 20 when the lower hierarchy reference is changed from the prohibited condition to the permitted condition.

When the management-node list is displayed on the display unit 22 by the behavior illustrated in FIG. 5, the administrator 72 can select the dealer who desires to change the lower hierarchy reference from the prohibited condition to the permitted condition via the operation unit 21 and instruct to change the lower hierarchy reference from the prohibited condition to the permitted condition, so as to request the support server 20 to change the lower hierarchy reference from the prohibited condition to the permitted condition. Here, it is basically preferred that the administrator 72 does not change the lower hierarchy reference from the prohibited condition to the permitted condition. For example, to reduce the disadvantage for the customer that is managed by the dealer who cannot manage the customer due to bankruptcy or similar reason, the administrator 72 changes the lower hierarchy reference from the prohibited condition to the permitted condition only regarding the dealer who cannot manage the customer, such that the administrator 72 itself takes over the customer from the dealer.

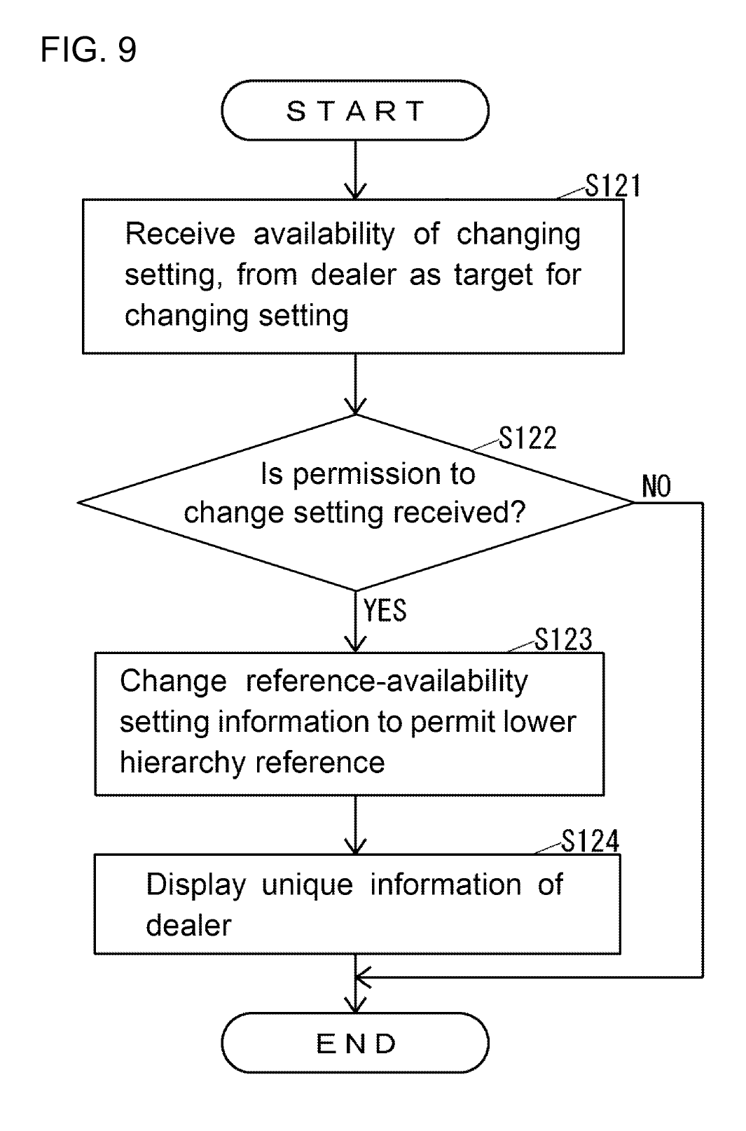

When changing the lower hierarchy reference from the prohibited condition to the permitted condition is requested, the control unit 25 of the support server 20 executes the behavior illustrated in FIG. 9.

FIG. 9 illustrates the behavior of the support server 20 when the lower hierarchy reference is changed from the prohibited condition to the permitted condition.

As illustrated in FIG. 9, the reference-availability setting unit 25c receives the availability of changing the setting from the dealer as the target for changing the setting (in step S121). For example, the reference-availability setting unit 25c transmits the information of the screen for receiving the availability of changing the setting, to the user terminal of the dealer as the target for changing the setting. When the control unit of the user terminal receives the information of the screen for receiving the availability of changing the setting, the control unit displays the screen on the display unit based on the received information. Then, when the dealer after login to the support server 20 inputs the availability of changing the setting via the operation unit of the user terminal, the control unit of the user terminal transmits the input contents to the support server 20. Accordingly, the reference-availability setting unit 25c can receive the availability of changing the setting, from the dealer as the target for changing the setting.

After the process in step S121, the reference-availability setting unit 25c determines whether or not permission to change the setting is received in step S121 (in step S122).

When the reference-availability setting unit 25c determines, in step S122, that permission to change the setting is received, the reference-availability setting unit 25c changes the reference-availability setting information 24c to permit the lower hierarchy reference (in step S123).

Subsequently, the unique-information managing unit 25b displays the unique information of the dealer after its setting has been changed in step S123, in the management-node list displayed on the display unit 22 (in step S124), and then terminates the behavior illustrated in FIG. 9.

When the reference-availability setting unit 25c determines, in step S122, that permission to change the setting is not received, the reference-availability setting unit 25c terminates the behavior illustrated in FIG. 9.

Next, a description will be given of the behavior of the support server 20 when the dealer requests the use of the function.

The dealer needs to login to the support server 20 before requesting the use of the function from the support server 20. When the dealer instructs the user terminal to login to the support server 20, the user terminal transmits the login ID and password input from the dealer to the support server 20 via the network 11, so as to request the support server 20 to cause the login of the dealer. The request of login from the user terminal causes the control unit 25 of the support server 20 to: permit the login of the dealer when the combination of the ID and the password transmitted from the user terminal is included in the management-node information 24b; and not permit the login of the dealer when the combination of the ID and the password transmitted from the user terminal is not included in the management-node information 24b.

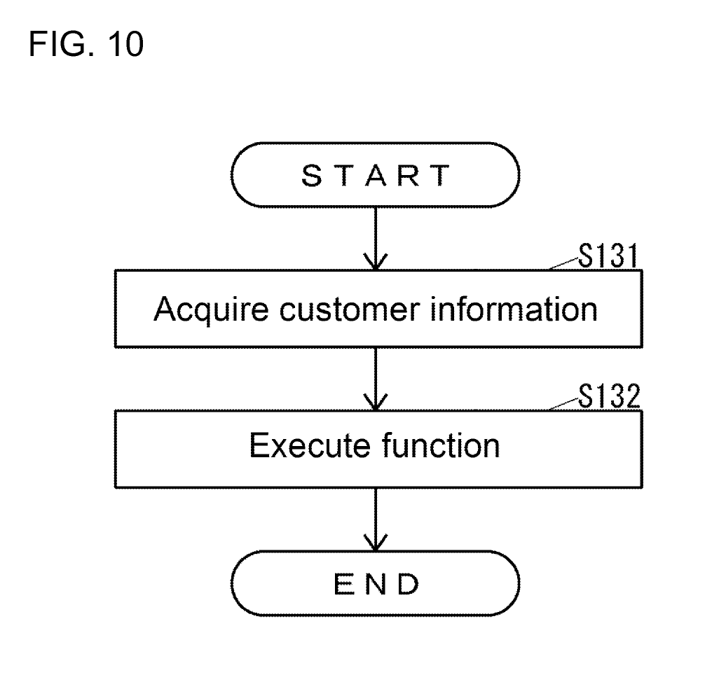

The dealer whose login is permitted by the support server 20 instructs the user terminal to cause the use of the function provided by the support server 20, the user terminal requests the use of the function from the support server 20 via the network 11. When the use of the function is requested from the user terminal, the control unit 25 of the support server 20 executes the behavior illustrated in FIG. 10.

FIG. 10 illustrates the behavior of the support server 20 when the use of the function is requested.

As illustrated in FIG. 10, the unique-information managing unit 25b acquires the customer information included in the unique information of the dealer during login, from the database server 30 (in step S131).

Subsequently, the function execution unit 25a executes the function using the customer information acquired in step S131 (in step S132), and then terminates the behavior illustrated in FIG. 10.

As described above, the support server 20 determines the availability to reference the customer information of the dealer based on the setting in the reference-availability setting information 24c (in step S103). This hides the customer information of the dealer from the administrator 72. That is, the disclosure hides the customer information of the dealer from the administrator 72 in a multi-tenant fleet management application. Accordingly, the support server 20 can increase a feeling of security of the user and increase the count of the users.

When the support server 20 receives the instruction to change the setting from prohibition of the lower hierarchy reference to permission of the lower hierarchy reference from the administrator 72, only with permission from the dealer as target for changing the setting (YES in step S122), the support server 20 changes the setting (in step S123). With this configuration, when the customer information of the dealer is hidden from the administrator 72, the support server 20 continues hiding the customer information of the dealer from the administrator 72 without permission from the dealer. This increases a feeling of security of the user and increases the count of the users.

Here, when the support server 20 receives the instruction to change the setting from prohibition of the lower hierarchy reference to permission of the lower hierarchy reference from the administrator 72, the support server 20 may change the setting without receiving permission from the dealer as the target for changing the setting.

The database server 30 is hardware different from the support server 20 in this embodiment. However, the support server 20 may double as the database server 30.

In the description above, immediately after the dealer is added to the management-node list by the administrator 72, the support server 20 receives the setting as prohibition of the lower hierarchy reference. However, the support server 20 may receive the setting as prohibition of the lower hierarchy reference at any time point after the dealer is added to the management-node list by the administrator 72.

In the description above, when the dealer is added to the management-node list by the administrator 72, the support server 20 receives the setting for availability of the lower hierarchy reference corresponding to the operation from the administrator 72. However, when the dealer is added to the management-node list by the administrator 72, the support server 20 may automatically add the setting as prohibition of the lower hierarchy reference to the added dealer, to the reference-availability setting information 24c.

In the description above, the support server 20 determines the availability of reference to the unique information of the dealer, that is, a person in a lower hierarchy by the administrator 72 having authority to manage the dealer, that is, a person in an upper hierarchy compared with the dealer, corresponding to the reference-availability setting information 24c. However, the combination of the person in the upper hierarchy and the person in the lower hierarchy might not be the combination of the administrator 72 and the dealer. For example, when there is a hierarchical structure between a plurality of dealers, the support server 20 may determine the availability of reference to the unique information of a dealer in a lower hierarchy by a dealer having authority to manage another dealer, that is, a dealer in an upper hierarchy, corresponding to the reference-availability setting information 24c. The support server 20 may determine the availability of reference to the unique information of a SC, that is, a person in a lower hierarchy by a RHQ having authority to manage the SC, that is, a person in an upper hierarchy compared with the SC, corresponding to the reference-availability setting information 24c.

In the description above, the administrator 72 inputs an instruction to the support server 20 via the operation unit 21 of the support server 20, to confirm the information output from the support server 20 via the display unit 22 of the support server 20. However, the administrator 72 may input an instruction to the support server 20 and may confirm the information output from the support server 20 via the operation unit and the display unit of a computer communicatively connected to the support server 20 via the network 11.

### Second Embodiment

The following describes a second embodiment of the disclosure with reference to the drawings. The second embodiment is different from the first embodiment in that the usage (reference) of the customer information is not managed based on the reference-availability setting, but the usage (reference) of the customer information is managed based on the storage destination of the customer information.

Firstly, a description will be given of the configuration of a system 10a according to this embodiment.

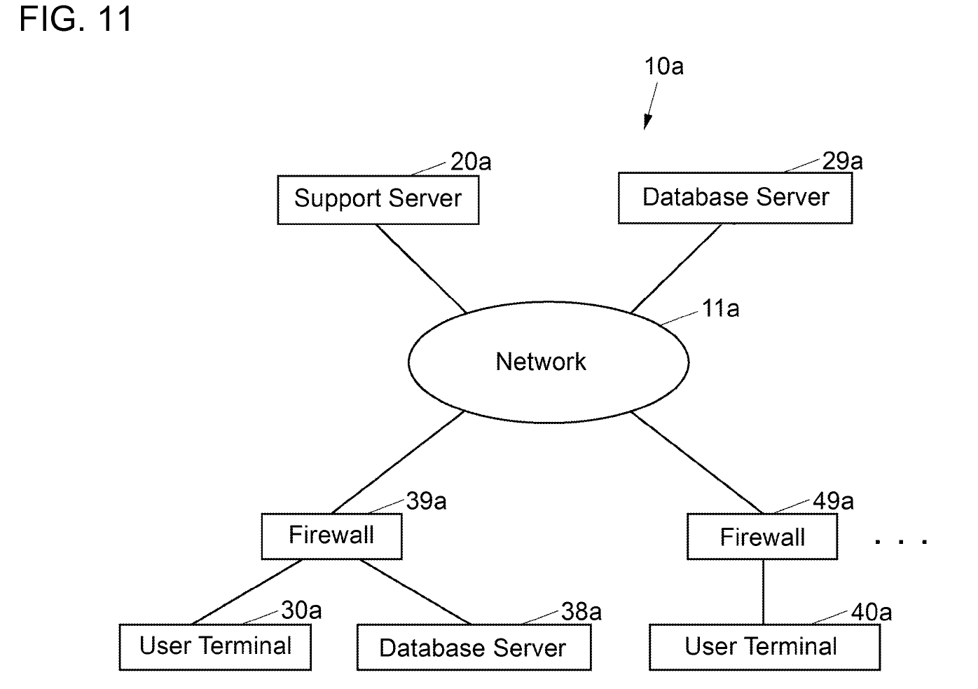

FIG. 11 illustrates the configuration of the system 10a according to this embodiment.

As illustrated in FIG. 11, the system 10a includes a support server 20a, a database server 29a, a user terminal 30a used by a dealer 53a (described later), a database server 38a, a firewall 39a, a user terminal 40a used by a dealer 54a (described later), and a firewall 49a. The support server 20a supports sales in a plurality of dealers who sell products to customers, as the support system. The database server 29a stores the customer information indicative of specific contents related to the customers. The database server 38a stores the customer information. The firewall 39a maintains the security of the network such as Local Area Network (LAN) that the user terminal 30a belongs to. The firewall 49a maintains the security of the network such as LAN that the user terminal 40a belongs to.

The support server 20a, the database server 29a, the user terminal 30a, the database server 38a, and the user terminal 40a are communicatively connected to one another via a network 11a such as the Internet.

Here, the system 10a can include a lot of user terminals and firewalls that are similar to the user terminal 30a and the firewall 39a, other than: the user terminal 30a and the firewall 39a; and the user terminal 40a and the firewall 49a.

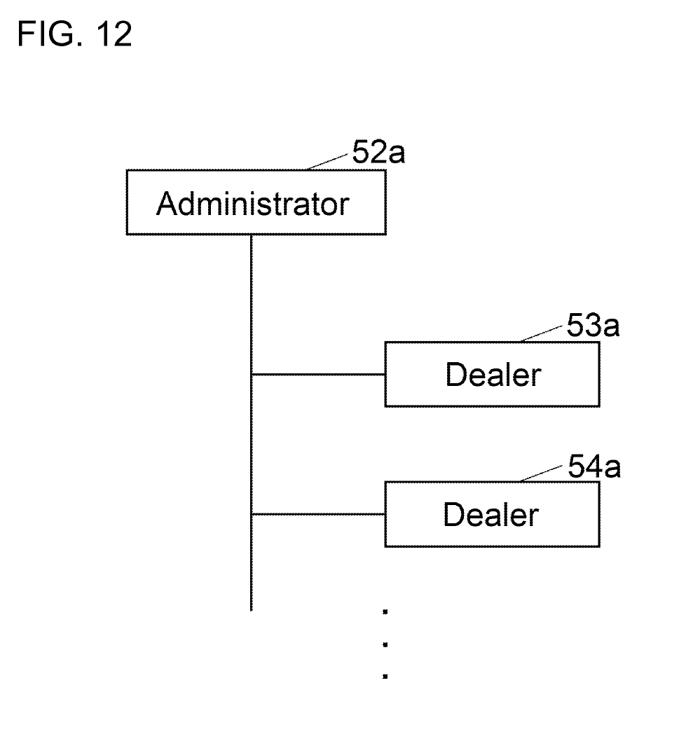

FIG. 12 illustrates the relationship between an administrator 52a of the support server 20a (see FIG. 11) and dealers.

As illustrated in FIG. 12, users of the system 10a (see FIG. 11) include: the administrator 52a of the support server 20a; and a dealer 53a and a dealer 54a who sell products to customers.

Here, users of the support server 20a may include a lot of dealers other than the dealer 53a and the dealer 54a.

The administrator 52a is the person who has authority to manage the dealers in the support server 20a (see FIG. 11) and who maintains and operates the support server 20a. The administrator 52a is, for example, a sales company of a manufacturer of the product, which the dealer sells to the customer.

The dealer is the person managed by the administrator 52a in the support server 20a. However, the dealer is another juridical person independent from the administrator 52a, and can handle not only the product of the administrator 52a but also any product such as a competing product to the product of the administrator 52a.

The support server 20a and the database server 29a illustrated in FIG. 11 exist in an on-premise environment or on a cloud network of the administrator 52a (see FIG. 12).

The database server 29a is constituted of, for example, a computer such as a Personal Computer (PC). The database server 29a stores the customer information for each dealer. The customer information includes a plurality of items of information. For example, the items of the customer information include the name of a customer. The items of the customer information include various attributes of the product possessed by the customer, for example, the model name, the setting, the state, and the use history of the product possessed by the customer.

The database server 38a is constituted of, for example, a computer such as a PC. The database server 38a stores the customer information of the dealer 53a alone.

The user terminals included in the system 10a are used by respective different dealers. For example, the users of the user terminals 30a and 40a are the respective dealers 53a and 54a (see FIG. 12).

The user terminal 30a, the database server 38a, and the firewall 39a exist in an on-premise environment of the dealer 53a.

The user terminal 40a and the firewall 49a exist in an on-premise environment of the dealer 54a. Here, a database server similar to the database server 38a may also exist in the on-premise environment of the dealer 54a.

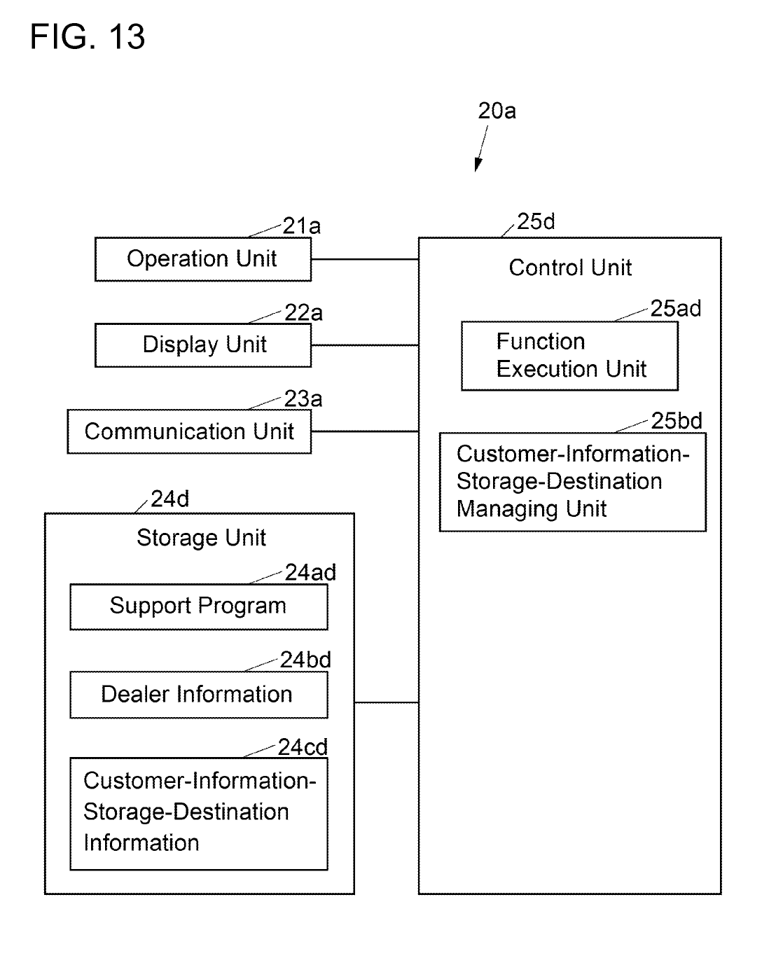

FIG. 13 illustrates the configuration of the support server 20a.

A storage unit 24d can store dealer information 24bd indicative of various contents related to the dealer. For example, the dealer information 24bd includes the login ID and password of the dealer and the name of the dealer.

The storage unit 24d can store customer-information-storage-destination information 24cd indicative of the storage destination of the customer information.

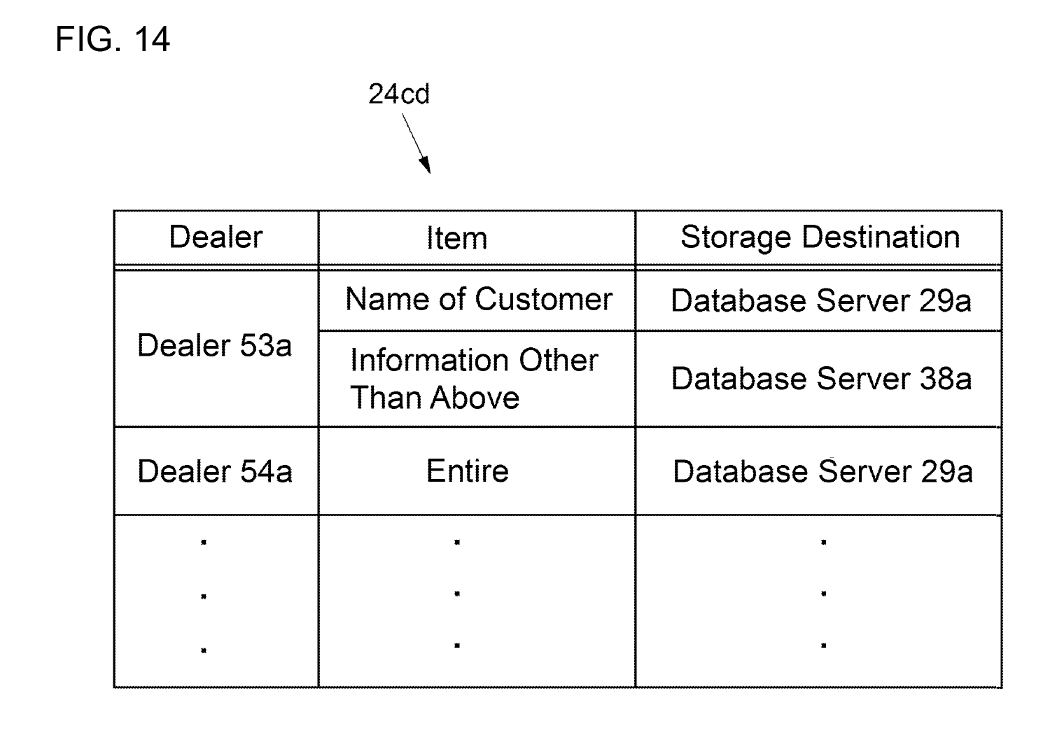

FIG. 14 illustrates an example of the customer-information-storage-destination information 24cd.

As illustrated in FIG. 14, the customer-information-storage-destination information 24cd is the information as the combination of the dealer, the item of the customer information, and the storage destination. According to the customer-information-storage-destination information 24cd illustrated in FIG. 14, for example, the information of the item “Name of Customer” among the customer information of the dealer 53a is stored in the database server 29a. The information of the item other than “Name of Customer” among the customer information of the dealer 53a is stored in the database server 38a existing in the on-premise environment of the dealer 53a. All the customer information of the dealer 54a is stored in the database server 29a.

A control unit 25d (see FIG. 13) executes a support program 24cd stored in the storage unit 24d, so as to function as a function execution unit 25ad and a customer-information-storage-destination managing unit 25bd. The function execution unit 25ad executes a specific function using (referencing) the customer information. The customer-information-storage-destination managing unit 25bd manages the storage destination of the customer information for each dealer.

The function executed by the function execution unit 25ad is similar to the function executed by the function execution unit 25ad.

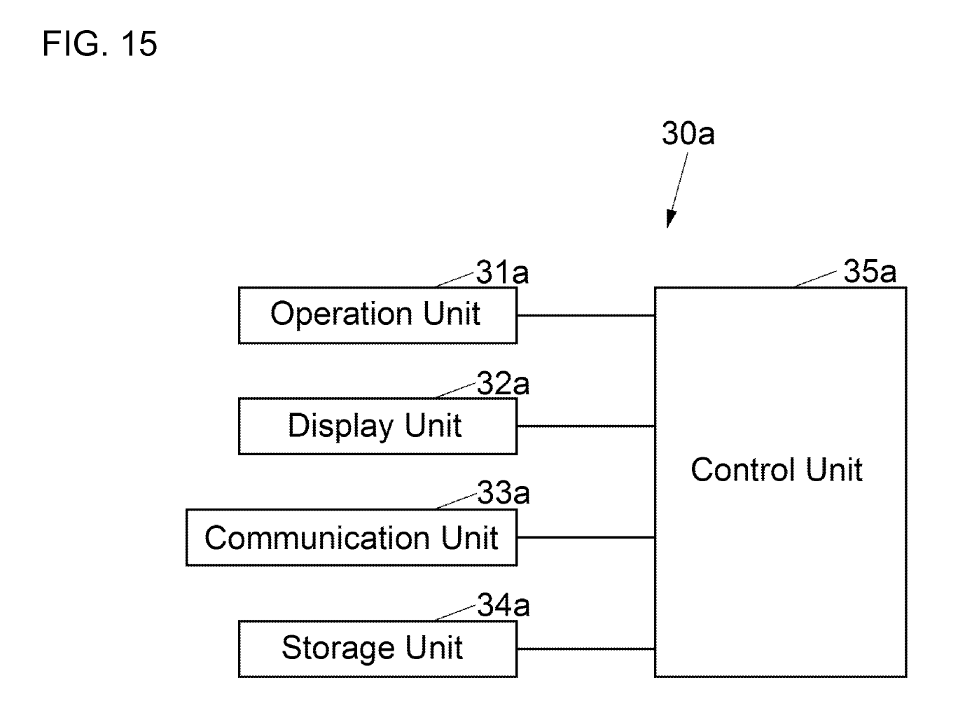

FIG. 15 illustrates the configuration of the user terminal 30a.

As illustrated in FIG. 15, the user terminal 30a includes an operation unit 31a, a display unit 32a, a communication unit 33a, a storage unit 34a, and a control unit 35a. The operation unit 31a is an input device that receives inputs of various operations, for example, a computer mouse and a keyboard. The display unit 32a is a display device that displays various kinds of information, for example, an LCD. The communication unit 33a is a network communication device that communicates with an external device via the network 11a (see FIG. 11). The storage unit 34a is a storage device that stores a program and various data, for example, an HDD. The control unit 35a controls the entire user terminal 30a. The user terminal 30a is constituted of, for example, a computer such as a PC and a tablet terminal.

The control unit 35a includes, for example, a CPU, a ROM, which stores a program and various data, and a RAM, which is used as a work area of the CPU. The CPU can execute the program stored in the ROM or the storage unit 34.

Here, the configuration of the user terminal included in the system 10a (see FIG. 11), for example, the user terminal 40a (see FIG. 11) is similar to the configuration of the user terminal 30a.

The following describes the behavior of the support server 20a.

Firstly, a description will be given of the behavior of the support server 20a when the dealer 53a requests the use of the function.

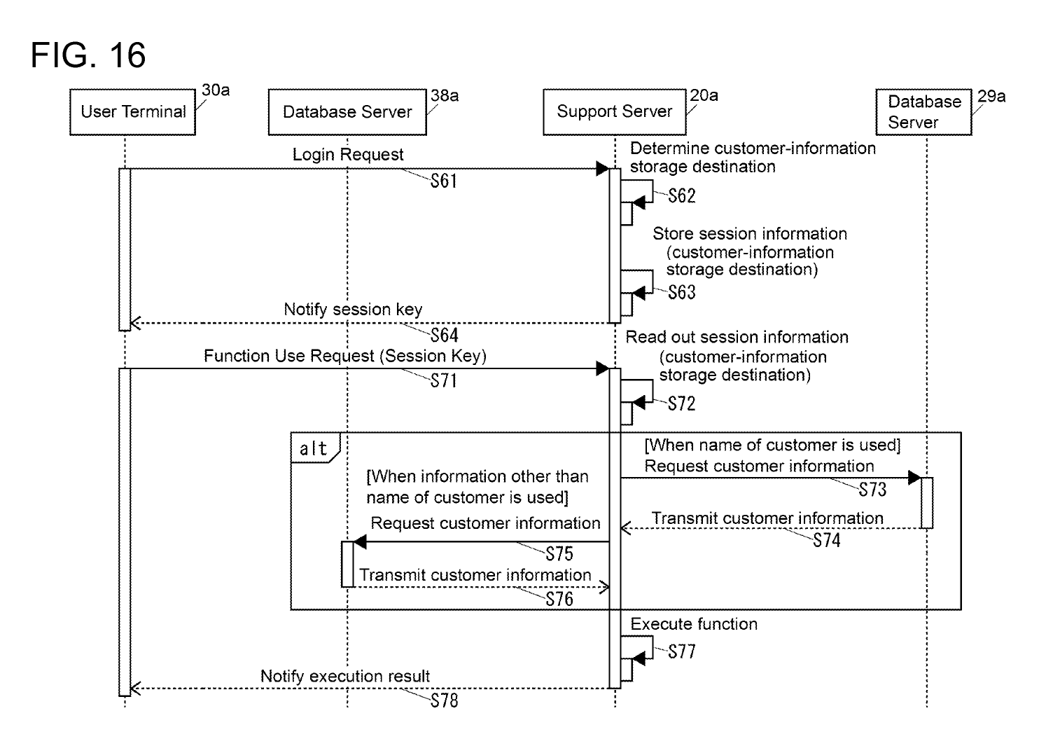

FIG. 16 illustrates the behavior of the system 10a when the dealer 53a requests the use of the function from the support server 20a.

As illustrated in FIG. 16, when the dealer 53a instructs the user terminal 30a to login to the support server 20a via the operation unit 31a, the control unit 35a of the user terminal 30a requests the login of the dealer 53a to the support server 20a via the communication unit 33a (in step S61). Here, the control unit 35a transmits the login ID and password, which are input via the operation unit 31a, of the dealer 53a to the support server 20a via the communication unit 33a, so as to request the support server 20a to cause the login of the dealer 53a.

When the login is requested in step S61, the customer-information-storage-destination managing unit 25bd of the support server 20a confirms that the combination of the ID and password transmitted in step S61 from the user terminal 30a is included in the dealer information 24bd, and then determines the storage destination of the customer information of the dealer 53a based on the customer-information-storage-destination information 24cd (in step S62). Here, when the customer-information-storage-destination managing unit 25bd cannot confirm that the combination of the ID and the password transmitted from the user terminal 30a in step S61 is not included in the dealer information 24bd, the customer-information-storage-destination managing unit 25bd terminates the behavior illustrated in FIG. 16 without executing the process after step S62.

When the customer-information-storage-destination information 24cd is the information illustrated FIG. 14, in step S62, the customer-information-storage-destination managing unit 25bd determines the database server 29a as the storage destination of the information of the item “Name of Customer” among the customer information of the dealer 53a, and determines the database server 38a as the storage destination of the information of the item other than “Name of Customer” among the customer information of the dealer 53a.

After the process in step S62, the customer-information-storage-destination managing unit 25bd stores the storage destinations determined in step S62 as session information in an in-memory database (cache) (in step S63). Here, methods for realizing cache storing the session information include an SQL server, a Key-Value Store (KVS), a session management service provided by a cloud service provider, and similar method.

After the process in step S63, the customer-information-storage-destination managing unit 25bd notifies the user terminal 30a about the session key generated in step S63 via the communication unit 23a (in step S64). The control unit 35a of the user terminal 30a receives the session key notified in step S64 from the support server 20a via the communication unit 33a.

After the user terminal 30a receives the session key notified from the support server 20a in step S64, when the dealer 53a instructs the user terminal 30a to cause the use of the function provided by the support server 20a via the operation unit 31a, the control unit 35a of the user terminal 30a requests the use of the function from the support server 20a via the communication unit 33a (in step S71). Here, the control unit 35a transmits the session key notified in step S64 from the support server 20a and the request for the use of the function, to the support server 20a via the communication unit 33a.

When the use of the function is requested in step S71, the customer-information-storage-destination managing unit 25bd of the support server 20a reads out the storage destination stored as the session information in the cache, based on the session key transmitted in step S71 from the user terminal 30a (in step S72).

When the information of the item “Name of Customer” among the customer information of the dealer 53a is used (referenced) during the execution of the function whose use is requested in step S71, the function execution unit 25ad of the support server 20a requests the information of the item “Name of Customer” among the customer information of the dealer 53a from the database server 29a via the communication unit 23a, based on the information of the storage destination read out in step S72 (in step S73). Then, the database server 29a transmits the information of the item “Name of Customer” among the customer information of the dealer 53a to the support server 20a (in step S74).

When the information of the item other than “Name of Customer” among the customer information of the dealer 53a is used (referenced) during the execution of the function whose use is requested in step S71, the function execution unit 25ad requests the information of the item other than “Name of Customer” among the customer information of the dealer 53a from the database server 38a via the communication unit 23a, based on the information of the storage destination read out in step S72 (in step S75). Then, the database server 38a transmits the information of the item other than “Name of Customer” among the customer information of the dealer 53a as the information requested from the support server 20a, to the support server 20a (in step S76).

Here, at the time of the communication in step S75 and step S76, the support server 20a and the database server 38a are connected to each other by a virtual network such as a Secure Socket Layer Virtual Private Network (SSL-VPN).

The function execution unit 25ad uses (references) the information transmitted by the process in step S74 or the process in step S76 so as to execute the function (in step S77).

Then, the function execution unit 25ad notifies the user terminal 30a about the result of the execution of the function in step S77 via the communication unit 23a (in step S78). Then, when the control unit 35a of the user terminal 30a receives the result notified in step S78 from the support server 20a via the communication unit 33a, the control unit 35a displays the received result on the display unit 32a. Accordingly, the dealer 53a can detect the result of the execution of the function instructed to be used, via the display unit 32a.

Next, a description will be given of the behavior of the support server 20a when the dealer 54a requests the use of the function.

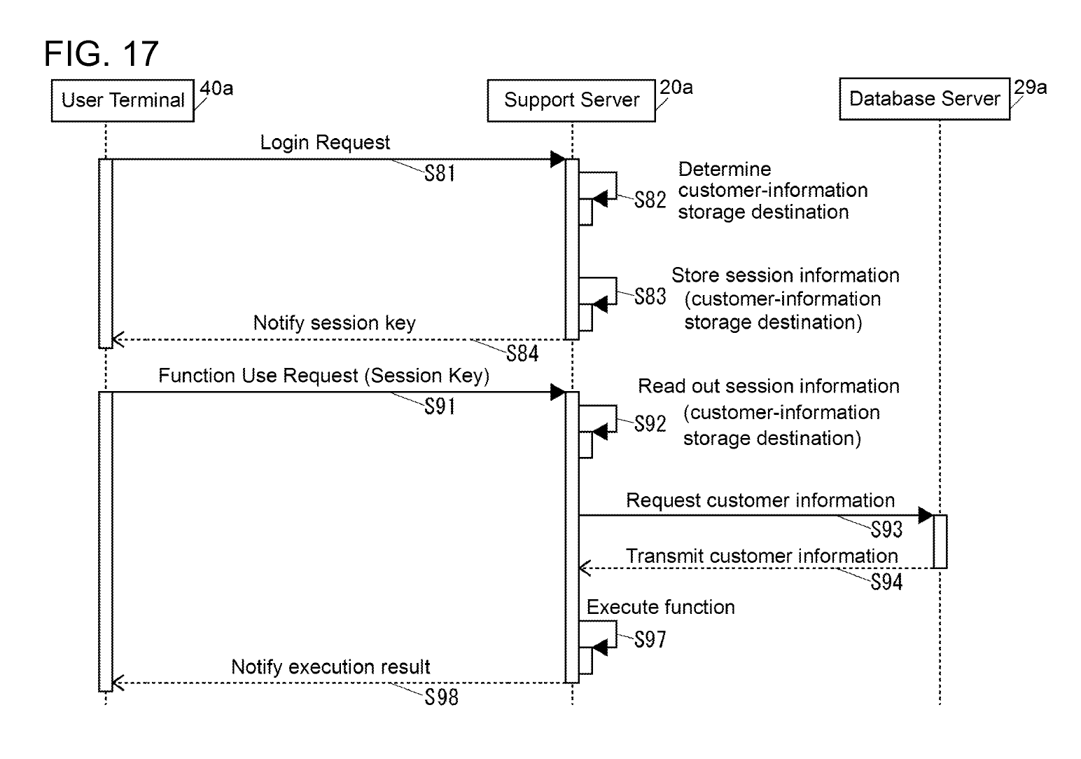

FIG. 17 illustrates the behavior of the system 10a when the dealer 54a requests the use of the function from the support server 20a.

As illustrated in FIG. 17, when the dealer 54a instructs the user terminal 40a to login to the support server 20a via the operation unit of the user terminal 40a, the system 10a executes the processes in steps S81 to S84 similar to the processes in steps S61 to S64 illustrated in FIG. 16.

However, when the customer-information-storage-destination information 24cd is the information illustrated in FIG. 14, in step S82, the customer-information-storage-destination managing unit 25bd determines the database server 29a as all the storage destination of the customer information of the dealer 54a.

After the user terminal 40a receives the session key notified from the support server 20a in step S84, when the dealer 54a instructs the user terminal 40a to cause the use of the function provided by the support server 20a via the operation unit of the user terminal 40a, the system 10a executes the processes in steps S91 and S92 similar to the processes in steps S71 and S72 illustrated in FIG. 16.

Subsequently, the function execution unit 25ad of the support server 20a requests the customer information of the dealer 54a from the database server 29a via the communication unit 23a based on the information of the storage destination read out in step S92 (in step S93). Then, the database server 29a transmits the information requested from the support server 20a among the customer information of the dealer 54a, to the support server 20a (in step S94).

When the process in step S94 terminates, the system 10a executes the processes in step S97 and step S98 similar to the processes in step S77 and step S78 illustrated in FIG. 16.

As described above, the support server 20a and the support program 24cd can deal with all the dealers using one system. Accordingly, it is not necessary to prepare one system for each dealer, thus reducing the management load on the administrator 52a. Additionally, since it is not necessary to prepare one system for each dealer, this also reduces the development load.

The support server 20a uses (references) the information stored in the storage destination managed in the customer-information-storage-destination information 24cd regarding: the dealer who has requested the use of the function; and the item used (referenced) for execution of the requested function (in step S73, S75 or S93), so as to execute the function (in step S77 or S97). That is, the support server 20a changes the storage destination of the customer information used (referenced) for execution of the function for each dealer and for each item. Accordingly, the support server 20a can store the customer information of the dealer in the storage destination desired by the dealer for each item. Thus, the support server 20a can increase a feeling of security of the user and increase the count of the users.

When the dealer feel uncomfortable storing its own customer information in the database server 29a outside its own on-premise environment even if the customer information is partially stored, the dealer can request the administrator 52a to cause the support server 20a to use (reference) the customer information stored in the database server 38a existing in its own on-premise environment. By simply setting the customer-information-storage-destination information 24cd corresponding to the request from the dealer, the administrator 52a can cause the support server 20a to use (reference) the customer information stored in the database server 38a.

As described above, the disclosure realizes the cooperation with the on-premise environment for each dealer in a multi-tenant fleet management application.

Here, in this embodiment, the support server 20a has the configuration that changes the storage destination of the customer information used for execution of the function for each dealer and for each item. The support server 20a may have the configuration that does not change the storage destination of the customer information used (referenced) for execution of the function depending on the item, but changes the storage destination depending only on the dealer.

In this embodiment, the database server 29a is hardware different from the support server 20a. However, the support server 20a may double as the database server 29a.

In this embodiment, the database server 38a is hardware different from the user terminal 30a. However, the user terminal 30a may double as the database server 38a.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A support system comprising:
a function execution circuit that uses customer information indicative of a specific content related to a customer to execute a specific function;
a customer-information managing circuit that manages the customer information for each dealer; and
a usage-availability setting circuit that sets availability for use of the customer information from a person having authority to manage the dealer for each of the dealers; wherein
the customer-information managing circuit determines the availability for use based on setting by the usage-availability setting circuit.

2. The support system according to claim 1, wherein:
the customer-information-storage-destination managing circuit manages a storage destination of the customer information for each of the dealers; and
when the dealer requests use of the function, the function execution circuit uses the customer information stored in the storage destination managed by the customer-information-storage-destination managing circuit for the dealer who has requested the use of the function, to execute the function.

3. The support system according to claim 1, wherein when the usage-availability setting circuit receives an instruction, from the person having authority, to change setting from prohibition of the use to permission of the use, the usage-availability setting circuit changes the setting only when the change of the setting is permitted by the dealer as a target for the changing of the setting.

4. The support system according to claim 2, wherein:
the customer information includes a plurality of items of information;
the customer-information-storage-destination managing circuit manages the storage destination for each of the dealers and for each of the plurality of items; and
when one of the plurality of dealers requests use of the function, the function execution circuit uses the information stored in the storage destination managed by the customer-information-storage-destination managing circuit for the dealer who has requested the use of the function and the item used for execution of the requested function, to execute the function.

5. A non-transitory computer-readable recording medium storing a control program for controlling a support system, the control program causing the support system to function as:
a function execution circuit that uses customer information indicative of a specific content related to a customer to execute a specific function;
a customer-information managing circuit that manages the customer information for each dealer; and
a usage-availability setting circuit that sets availability for use of the customer information from a person having authority to manage the dealer for each of the dealers; wherein
the customer-information managing circuit determines the availability for use based on setting by the usage-availability setting circuit.

6. A support method comprising:
using, via a function execution circuit, customer information indicative of a specific content related to a customer to execute a specific function;
managing, via a customer-information managing circuit, the customer information for each dealer; and
setting, a usage-availability setting circuit, availability for use of the customer information from a person having authority to manage the dealer, for each of the dealers; and
determining the availability for use based on the setting.
